(19) United States
(12) Patent Application Publication
(10) Pub. No.: US 2002/0087970 A1
(43) Pub. Date: Jul. 4, 2002

(54) Electronic media distribution

(76) Inventors: Martin Rex Dorricott, Basingstoke (GB); Richard Daniel Foster, Fordingbridge (GB)

Correspondence Address: William S. Frommer, Esq., FROMMER LAWRENCE & HAUG LLP, 745 FIFTH AVENUE, NEW YORK, NY, 10151, US

(21) Appl. No.: 10/006,336

(22) Filed: Dec. 4, 2001

Related U.S. Application Data
(63) Continuation of application No. PCT/GB01/01466, filed on Mar. 30, 2001.

(30) Foreign Application Priority Data
Apr. 5, 2000 (GB) 0008442.6
Apr. 5, 2000 (GB) 0008395.6

(51) Int. Cl. H04N 7/16; H04H 9/00; H04N 7/173

(52) U.S. Cl. 725/22; 725/20; 725/115

(57) ABSTRACT

A system for electronic media distribution comprises means for generating a plurality of media items; a data repository for storing a respective metadata item containing metadata relating to the generation of the corresponding media item; means for electronically distributing at least some of the media items to a plurality of end-users; means for detecting reception by the end-users of the media items; and means for associating, with each metadata item relating to an electronically distributed media item, a reception indicator indicative of the number of users receiving that media item.

This invention relates to electronic media distribution.

Electronic media distribution to a plurality of end-users, for example digital broadcasting of audio/video media items, is a well established art.

Media items are generated by, for example, a television production company commissioned by a broadcasting company. The commissioning and production process involve a large amount of planning to ensure that the acquisition or generation of the media item takes place as efficiently as possible, and that the media item itself is one which will be commercially attractive in the market. Furthermore, the involvement of numbers of actors, staff and companies means that issues relating to copyright ownership or licensing for the media items need to be addressed by contractual agreement between the parties when the media item is originated.

It is known to conduct audience research to determine how popular an electronically distributed media item is or to derive charging information for the media item itself or for advertising content associated with the media item.

This invention provides a system for electronic media distribution, the system comprising:

means for generating a plurality of media items;

a data repository for storing a respective metadata item containing metadata relating to the generation of the corresponding media item;

means for electronically distributing at least some of the media items to a plurality of end-users;

means for detecting reception by the end-users of the media items; and

means for associating, with each metadata item relating to an electronically distributed media item, a reception indicator indicative of the number of users receiving that media item.

The invention builds on the previously separate processes of media item generation and audience assessment by providing a data repository (e.g. a database) which stores two important features about media items: (a) metadata relating to the creation of the media item; and (b) a reception indicator indicative of the popularity of the media item.

By tying these two data items together in a single database, the invention provides a way of linking back popularity information to planning information derived at the time the media item was generated. This pairing of information provides a highly useful source of data for the planning of future media items.

As mentioned above, it is important to establish copyrights and other rights in media items. However, when the media item is broadcast, it may have been through an editing process or there may have been a significant time since the item was originally produced, which can make it difficult to establish ownership of copyrights or other rights. This can in turn make it difficult to ensure that the proper payment for use of the material is made to the correct party.

In another aspect this invention provides a system for electronic media distribution, the system comprising:

means for generating a plurality of media items;

a data repository for storing a respective metadata item containing metadata relating to copyright and/or ownership of the corresponding media item;

means for electronically distributing at least some of the media items to a plurality of end-users;

means for detecting the copyright and/or ownership metadata relating to media items actually distributed to end-users; and

means for generating payment information indicative of a required payment to the holder of rights defined by the copyright and/or ownership metadata.

In this aspect the invention provides a two-stage approach to the matter of charging for the use of copyright material in an electronic media distribution system.

Firstly, a data repository is maintained which ties each media item to a respective copyright owner. This is preferably arranged so that the link between the material and the owner can be made even if the material has been subjected to an editing or processing operation, or if the material was originated a considerable time before broadcast.

Secondly, the data repository is automatically referenced at the time of broadcast to detect the ownership of each media item to be electronically distributed

Further respective aspects and features of the invention are defined in the appended claims.

Embodiments of the invention will now be described with reference to the accompanying drawings, throughout which like parts are referred to by like references, and in which:

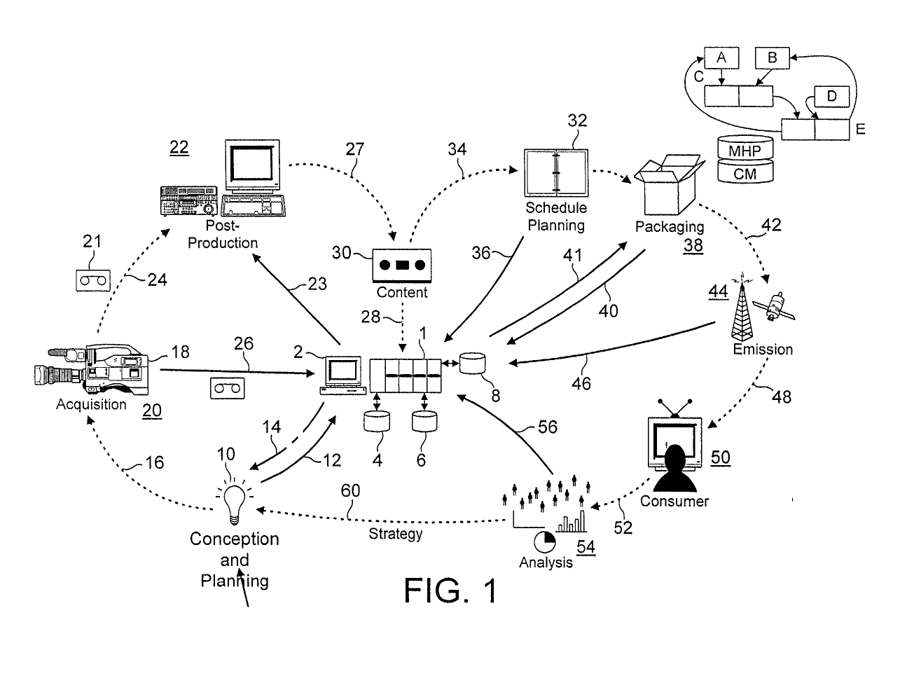

FIG. 1 is a schematic diagram of an electronic media distribution system;

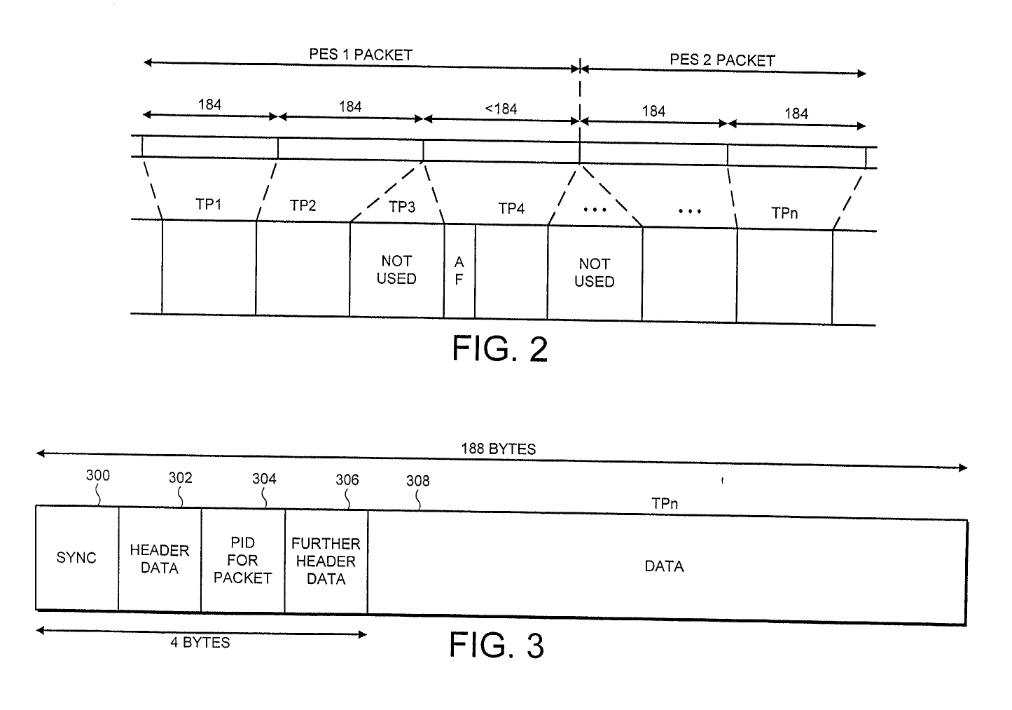

FIG. 2 is a schematic diagram illustrating the structure of an MPEG-2 transport stream; and

FIG. 3 is a schematic diagram illustrating the structure of an MPEG-2 transport packet.

An integrated system for uniquely identifying and tracking audio/video material items, in order to facilitate planning, acquisition and generation of audio/video productions will now be described with reference to FIG. 1. In general, the integrated system according to FIG. 1 provides a facility for identifying items of audio/video material within an audio/video production as well as the audio/video production itself, from conception, to acquisition, to generation, to viewing and analysis. This integrated system can be used to facilitate copyright licensing and billing for use of particular audio/video material items. As will be explained, the system for identifying uniquely the audio/video material items and the audio/video productions provides a facility for planning subsequent audio/video productions in accordance with previously produced audio/video productions and consumer analysis information representing the relative audience for these audio/video productions. The planning information, which was used to generate the audio/video production, and the consumer analysis information indicating a relative success of the audio/video production is fed back to enrich a knowledge base for generating subsequent productions.

FIG. 1 provides an illustrative representation of the integrated system for the planning, acquisition, production, emission and analysis of audio/video productions. In FIG. 1 an asset management system 1 is shown to comprise a data processor 2 which is arranged in operative association with a first program database 4, a rights database 6, and a consumer analysis database 8 the purpose and function of which will be explained shortly. The asset management system 1 is arranged to maintain a database in which Unique Metadata Identifier (UMID) which uniquely identifies items of audio/video material are associated with a Unique Program Identifier (UPID) which uniquely identifies a program. A program is an audio/video production which is comprised of a combination of items audio/video material items, some of which may be generated during an acquisition stage of the system. As a result each UPID will be associated with at least one UMID representing the audio/video material from which the program corresponding to the UPID is comprised.

The generation of the UPID in associate with the UMID will now be explained. At a first planning and concept stage 10 a format or sequence of audio/video material is identified. This is typically identified as a combination of scenes and within each scene a number of shots which represent action events within the scene. However each shot may require a number of takes. A take is an item of content from which audio/video material is generated which may result, for example, from a camera taking real time action which is recorded as a continuous event. The planning stage might also identify product placements and sponsorship items which must be included within the audio/video program. As represented by an arrow 12 it is at this stage which a UPID is assigned to the audio/video program. In preferred embodiments the asset management system is a central registry and the assignment of UPID is effected by sale, providing the unique UPID in exchange for money. The producers of the audio/video program at the planning and concept stage 10, may also interrogate the asset management system for viewing Figures produced when similar audio/video programs have been previously shown. This is also held in the asset management system 1 which is populated, as will be described shortly, with viewing Figures captured when an audio/video program is emitted. Hence the viewing Figures which form part of a collection of strategic information is received at the planning and concept stage 10 as represented by the broken line 14.

The term emitted will be used to described the distribution of the audio/video program on any medium, which includes terrestrial and satellite broadcast, as will as sale on video tape and digital versatile disc.

As indicated by the clockwise broken line arrow 16 the next stage in the system is the acquisition of the audio/video material from which the audio/video program is to generated. Therefore based on the planning information produced at the concept stage 10, the audio/video generation apparatus such as a camera 18 at the acquisition stage 20 is used by a camera crew to generate the audio/video material in accordance with the planning information. This might be for example at a sound stage or a similar environment such as an outside broadcast. The planning information however is not discarded at this stage but retained and passed with the audio/video material to a production stage 22 which is the next stage via the anti-clockwise arrow 24. However the planning information is also stored in the asset management system 1 for use in generating future audio/video programmes of a similar nature. This is represented by the arrow 26. At the acquisition stage 20 UMIDs are generated in association with the audio/video material items generated. Thus, for each take produced by the camera 18 a UMID is generated in association with that audio/video material. The UMIDs are then also transferred via the connecting arrow 26 to the asset management system 1 and stored in association with the UPID previously set up at the planning and conception stage 10. Additionally, UMID can be associated with a task or short storyboard position which itself is associated with the UPID. The audio/video material may be for example recorded onto a tape 21 which may include the UMIDs associated with the items of audio/video material. The tape is therefore representative of the audio/video material so far generated and from which the program is to be reproduced. The tape is therefore passed via arrow 24 to an editing stage which is represented generally as a post production stage 22.

During editing, items of audio/video material are combined from a greater set of audio/video material produced at the acquisition stage 20. This facilitated by additional information introduced at the acquisition stage 20, at which a plurality of takes are typically produced for each shot whereas in fact only one take is typically required for each shot to fulfil requirements of the program. Therefore, from a plurality of takes at least one is selected. The preferred shot may be indicated by a so called ‘Good Shot Marker’ (GSM) which then appears as metadata. The GSM may be added to the medium on which the audio/video material is recorded, such as the video tape 10, or may be stored separately with associated time codes indicating the in and out points of the take. The GSM is then combined with the metadata and UMID associated with the audio/video material item and stored as a data structure within the asset management system. This data structure forming the asset management of the data base will be described in a separate section. However the GSM is used during the post production stage to enable an efficient identification of the takes which are to be used to form the shots of the scenes. Furthermore, at the post production stage 22, other audio/video material may be combined with the material generated at the acquisition stage 20. The combined material is then assigned a further UMID, which is also stored in the asset management data base.

The editing performed at the post production stage 22 may make use of the planning information, received from the asset management system 1 as indicated by an arrow 23. This information may be used for example to ensure that product placements within the audio/video material items and sponsorship material is maintained in the edited version of the program.

As a result of the editing process, the audio/video material from which the program has been formed is now a reduced sub-set from that produced at the acquisition stage 20, but may also include audio/video material from archives or animation or graphics. As such the UMIDs which identify each item of audio/video material will have changed from the set of UMIDs identifying the audio/video material from that received from the acquisition stage 20. As a result an updated set of UMIDs associated with the UPID is communicated to the asset management system as represented by the arrow 28 which represents the audio/video material within the audio/video production represented on a storage medium 30. Furthermore, at the post production stage 22 the audio/video material associated with these UMIDs may be stored in the data base. The content of the audio/video program is therefore that produced from the editing at the post production stage 22. From the audio/video program 30, the next stage is a scheduling stage 32 which is introduced, in order to schedule the emission of the audio/video program which is therefore received via the connecting arrow 34. At the schedule planning stage 32 a time at which the audio/video program is, for example, to be broadcast is identified and a corresponding timeslot assigned which corresponds to the length of the time available. At this stage the UPID is mapped to a program identifier with the date and time of scheduling for broadcast of the program. As a result this information is also fed back to the asset management system 1 (represented as an arrow 36) so that the program identifier and date and time of scheduling can be associated with the UPID.

After the planning and scheduling stage 32 the video program is then packaged at a stage 38. At the packaging stage 38 character merchandising deals are identified in association with the characters which may appear in the audio/video program. Furthermore the advertisements and trailers are associated with the audio/video program. However with assistance of the UMIDs and the planning information held in the asset management system 1, the character merchandising deals may be identified in correspondence with the content of the audio/video material as described by the UMIDs. Furthermore in accordance with the planning information which identifies the product placements and sponsorship, advertisements can be appropriately selected to accompany the audio/video program. Again this is all achieved by interrogating the asset management system 1 which is represented by a further arrow 40, 41. Finally as represented by the clockwise arrow 42, the packaged program is sent for emission at a broadcast stage 44 on an appropriate format. The appropriate format may be for example digital video broadcasting in which case the program identifier may be added. The program identifier may be for example the transport identifier which is used to identify DVB packets forming a program, within a multiplexed stream of packets for other programs. However at the emission stage 44, the final version of the program to be broadcast is monitored so as to establish exactly what has been emitted. To this end, a further modification of the UMIDs associated with the UPID may be made to the effect that the content of the audio/video program in the form in which it is to be emitted is identified by logging the UMIDs associated with the content of the emitted program. However this may require the combination of UMIDs which describe the content of the audio/video program which has been adapted for emission. This is because the version of the program formed for emission may contain the content items of the un-adapted program and content items added to a particular version such as advertising material. As such, a hierarchical formation of UMIDs is required in which the UMIDs which describe the content of the un-adapted program and the UMIDs which describe the content of the additional material are combined to form a new UMID. The new UMIDs include a reference to the combined content items as a reference to the UMIDs which described theses content items in a recursive fashion. This is illustrated in FIG. 1, by boxes A and B, which represent UMIDs which described different content items of the un-adapted program. A new UMID for the program is illustrated as box C, which refers back to the UMIDs A and B. When the program is adapted for emission, further material is added. The UMID associated with this further material is represented by a UMID D. When the program is adapted for emission and the original content and the further material is formed, a new UMID E is formed to represent the content of the adapted version. The new UMID E is arranged to refer back to UMIDs A and B in a hierarchical fashion.

There may be different versions of the same program issued on different media. For example the form of the program which is broadcast may differ to a version of the program as recorded on to a digital versatile disc. For this reason a set of UMIDs for each version may differ as a result of the differing content. Each version of the program may therefore be assigned a different UPID identifying that version of the program. Therefore at the emission stage 44 an update of the asset management system 1 is effected as represented by the further arrow 46 so that the final UPID to UMID association is recorded for each emitted version of the program.

A clockwise broken arrow 48 represents the emission of the audio/video program to consumers. At a consumption stage 50 consumers are watching/listening to the audio/video production. At this stage however marketing information is gathered by monitoring the number of consumers which are listening and/or watching the audio/video program, when the program is broadcast, or monitoring the sales of the distributed program through pay-per-view, or sales of, for example, digital versatile discs. For the example in which the program is broadcast, the proportion of consumers viewing/listening the program might be gathered for example via a set top box. Typically such set top boxes are provided with a telephone line which is communicated to a marketing centre which monitors which programs are being watched by a selected sample of consumers from which marketing information and analysis is formed. This marketing information and analysis is acquired as represented by a clockwise broken arrow 52 to produce a relative proportion of a possible population viewing the audio/video program with respect to time to the effect that individual items of audio/video material associated with UMIDs may be evaluated as to the relative audience detected at the time of broadcast. The marketing information provided at an analysis stage 54 is then also fed to the asset management system 1 and associated with the corresponding UPID for the program. This information is stored in the consumer analysis data base 8. At the analysis stage 54 the program identifier is associated with the UPID and forwarded to the asset management system 1 via the connecting arrow 56.

The transport program identifier in combination with the time of emission is mapped to UPID within the database 8. The database 8, may therefore include a table matching the transport program identifiers 54 with the time of emission. With this information the corresponding UPID is added to the table, providing a match between UPID and program ID/time of emission. As such the time of day of consumer analysis at stage 50 is logged with respect to the time of emission at stage 44, providing a match between the emission process 48 and the analysis process 54. In further embodiments of the invention, the UPIDs and/or UMIDs may be converged. Furthermore, the UMID may be used to form a watermark within the audio/video program.

In the example case of digital video broadcasting, the transport programme identifiers may be the PIDs of the DVB standard, described below with reference to FIGS. 2 and 3.

The integrated system as represented in FIG. 1 is provided with a particular advantage in that the viewing Figures generated at the analysis stage 54 are fed back and associated with the UPID and with individual UMIDs associated with the audio/video material within the program. As such at a future planning and conception stage 10 for subsequent audio/video programs, the producers of the new program may interrogate the asset management system 1 and receive not only the production plans for the earlier program but the viewing Figures and analysis of consumer rating for the program and parts of the program. Each new audio/video program serves to further enrich the asset management system 1 from which future productions of programs may benefit. This benefit is therefore represented in FIG. 1 by a connecting arrow 60. In effect, therefore the integrated system shown in FIG. 1 provides a means for identifying all audio/video material associated with each audio/video program produced.

Example applications of this identification and tracking of audio/video material will now be explained. As will be appreciated the copyright of the audio/video program will be owned by the producers of that program. However the copyright of individual items of audio/video material may not belong to the producers. Through the integrated system of FIG. 1, each item of audio/video material is associated with a UMID. As such the asset management system 1 is provided with the database 6 in which the copyright owner of the audio/video material is stored with its corresponding UMID. As a result after the program has been packaged at stage 38 and emitted at stage 44, a list of licence requirements for audio/video material not owned by the production company can be generated and appropriate royalties calculated. The royalties may be calculated from a business management software application forming part of the asset management system 1. Furthermore because the integrated system provides a measure of the audience for each individual item of audio/video material, the licensing royalties may be established as a function of the relative audience for those parts of audio/video material.

The royalties may be stored as predetermined amounts of money (with or without index linking) against UMIDs or UPIDs.

A further example application of the audio/video material identification and tracking facility provided by the integrated system shown in FIG. 1 is for billing. This is because, as explained above, different media may be used to represent the same program and as such the program may differ to some extent between different media. As a result at the emission stage 44 the augmented content of each of the versions of the program on different media is analysed. This might be for example to identify product placement and sponsorship items which may be different between the different versions of the program identified. The UMIDs associated with this audio/video material can then be fed to a database. Such a database may be the database 8 of the asset management system 1. Therefore from the different items of audio/video material produced for the different versions of the program, a bill may be automatically generated in accordance with sponsorship and produce placement deals. This may be similarly effected using a business management application program forming part of the asset management system 1.

It will be appreciated from the foregoing description that one of the advantages of the integrated system shown in FIG. 1 is that audio/video productions can utilise planning and concept information of previous audio/video productions. Furthermore audio/video productions can also benefit from marketing information providing a relative measure of consumer demand for previous audio/video productions and parts of the productions. As subsequent audio/video productions generate further planning information, and market analysis information, which is fed back and incorporated into the asset management system 1, the asset management system 1 is further enriched to the benefit of further productions. The term emitted will be used to described the distribution of the audio/video program on any medium, which includes terrestrial and satellite broadcast, as will as sale on video tape and digital versatile disc.

Referring now to FIG. 2, the structure of an MPEG-2 transport stream (TS) used in some examples of digital video broadcasting systems will now be described.

The TS is a convenient way of transporting compressed data—generally but not exclusively television programmes—over transmission media or environments subject to relatively high error rates such as a bit error rate (BER) of greater than 10⁻⁴. (This contrasts with the so-called program stream (PS) format which is intended for quasi error free media such as CD-ROMs where the BER is expected to be more like 10⁻¹⁰). So, the TS format is well suited to terrestrial or satellite broadcasting of television programmes.

In order to alleviate the effects of bit errors, the data is divided up into relatively short transport “packets” which are 188 bytes long. The central row of FIG. 2 schematically illustrates a repetitive structure of evenly-sized transport packets TP1 . . . TPn. The intention behind the division into transport packets is of course that if one packet is corrupted, another packet from the same television programme will hopefully not be corrupted and so the missing data can either be reconstructed (if error correction is employed) or concealed using the successfully recovered data.

The structure of a transport packet is shown schematically in FIG. 3. Of the 188 bytes of the transport packet, the first 4 bytes are a transport packet header formed of an eight bit synchronisation word 300; three bit header data 302 containing flags indicating a transport priority, a payload unit start indicator (see below) and a transport error indicator; a 13 bit packet identifier (PID) 304 (see below) and a further six bits of header data including a transport scrambling control flag, an adaptation field control flag and a continuity counter so that missing packets can be detected.

The remaining 184 bytes 308 of the transport packet carry the data payload.

The data payload of a transport packet is taken from a packetised elementary stream (PES). A PES is formed by taking an MPEG-2 elementary stream—in other words, the output of a single MPEG-2 audio or video encoder—and dividing it up into packets. The packets do not have to be 184 bytes long, and in fact generally are of very different lengths to this. Indeed, while the detailed structure of a PES packet will not be described here (reference is made to standard textbooks on MPEG-2 such as “Digital Television”, H Benoit, 1997, ISBN 0 340 69190 5) it is sufficient to say that the length of a PES packet is defined by a 16 bit “packet length” variable in the PES packet header, so that PES packets could have a maximum length of 64 kilobytes.

So, as the PES packet may well be of a greater length than the payload capacity of a single transport packet, PES packets are generally partitioned up to fit into multiple transport packets. This process is illustrated in FIG. 2. Along the top of FIG. 2, two PES packets are illustrated (on an expanded horizontal scale compared to the TS packets below). A packet from PES 1 takes up three TS packets, TP1, TP2 and TP4. TP3 is unused, and so is padded with stuffing data. At the end of PES 1 packet, the last TS packet containing the PES 1 packet starts with a so-called adaptation field, which is also stuffing data equal in length to 184 bytes minus the remaining amount of data of that PES packet.

The process then continues for the packet from PES 2, and so on.

It is therefore clear that the TS can simultaneously transport more than one programme, each being composed of one or more PESs. So, in order to decode a particular programme, it is therefore clear that a conventional digital television receiver must be able to pick out the relevant TS packets from the transport stream and re-concatenate them into packets of the required PESs. Some further data tables are provided in the TS to allow this to take place efficiently.

(a) The Programme Allocation Table (PAT)

This table has to be included in the TS without any scrambling or conditional access, in accordance with the MPEG-2 standard. It can easily be located by the receiver as the PID for packets carrying this table is always defined as zero. The detailed structure of the PAT is described in many other places, but its relevance here is that it defines, for each programme carried by the TS, the PID of packets containing a programme map table (PMT) for that programme. The PMT PIDs can be arbitrary values apart from the reserved values of 0 and 1. So, once the PAT has been decoded from the TS, the PIDs of the PMTs can be used to access each PMT from the TS.

The PAT can also define the PID of an optional network information table (NIT)—see below.

(b) The Programme Map Table (PMT)

Each programme transmitted using the TS has a respective PMT. Again, the detailed structure of a PMT is complicated and is described well elsewhere, but it should be noted here that the PMT defines the PID(s) of the PES(s) making up that programme. The PMT can also carry ECM data (see the description of the CAT below).

(c) The Conditional Access Table (CAT)

This table is carried by TPs of PID=1 and contains data defining the CA system used for the PESs using CA.

As before, the detailed structure of the CAT is complicated and well documented elsewhere, but for the present purposes the following information is given.

Generally, conditional access or unscrambling systems require Conditional Access Messages (CAMs) formed of two pieces of information to unscramble a programme: one of the CAM constituents is the so-called Entitlement Control Message (ECM) carried with the respective PMT or carried in packets having a PID defined by that PMT, and the other is the so-called Entitlement Management Message (EMM) transmitted via packets having a PID defined by the CAT. Each of the ECM and the EMM is retransmitted every few seconds. The information derived from them is combined with information available at the STB, for example in the smart card 30, to provide the keys to unscramble the scrambled signal.

So, an important feature of the CAT is that it carries PID definitions to specify packets in that TS which carry EMM information for programmes carried by that TS.

There are further optional tables which are defined not by MPEG-2 but by the “DVB” broadcasting standard. These are grouped together under the general term “DVB-SI”, where SI stands for service information. Together, the SI tables provide information to allow the receiver to configure itself automatically and to build an electronic programme guide (EPG) to assist the user to make use of the receiver and the available programmes.

The DVB-SI data will now be described.

(a) Network Information Table (NIT)

This table carries data relating to a single broadcasting network having programmes carried by more than one TS, and in particular by more than one radio frequency (RF) carrier. The data might include RF frequencies or satellite channel numbers.

(b) Service Descriptor Table (SDT)

This lists the names of each programme service in the TS.

(c) Event Information Table (EIT)

This can relay information about broadcasting “events” in the same or another TS.

(d) Time and Date Table (TDT)

This table carries the current time and date to enable an update and synchronisation of the time and date held by the receiver or set top box (STB).

In so far as the embodiments of the invention described above are implemented, at least in part, using software-controlled data processing apparatus, it will be appreciated that a computer program providing such software control and a storage or transmission medium by which such a computer program is stored or transmitted are envisaged as aspects of the present invention.

Whilst the embodiments described above each include explicitly recited combinations of features according to different aspects of the present invention, other embodiments are envisaged according to the general teaching of the invention, which include combinations of features as appropriate, other than those explicitly recited in the embodiments described above. Accordingly, it will be appreciated that different combinations of features of the appended independent and dependent claims form further aspects of the invention other than those, which are explicitly recited in the claims.

It will be appreciated that the embodiments of the invention described above may of course be implemented, at least in part, using software-controlled data processing apparatus. For example, one or more of the components schematically illustrated in FIG. 1 may be implemented as a software-controlled general purpose data processing device or a bespoke program controlled data processing device such as an application specific integrated circuit, a field programmable gate array or the like. It will be appreciated that a computer program providing such software or program control and a storage, transmission or other providing medium by which such a computer program is stored are envisaged as aspects of the present invention.

1. A system for electronic media distribution, the system comprising:
means for generating a plurality of media items;
a data repository for storing a respective metadata item containing metadata relating to the generation of the corresponding media item;
means for electronically distributing at least some of the media items to a plurality of end-users;
means for detecting reception by the end-users of the media items; and
means for associating, with each metadata item relating to an electronically distributed media item, a reception indicator indicative of the number of users receiving that media item.

2. A system according to claim 1, in which the metadata item contains at least metadata relating to the planning or commissioning of the media item.

3. A system according to claim 1 or claim 2, in which the media items include audio and video items.

4. A system according to any one of the preceding claims, comprising means for associating a material identifying code with each media item for electronic distribution.

5. A system according to claim 4, comprising means for receiving the material identifying codes of media items received by end-users.

6. A system according to claim 5, in which the receiving means comprises a modem link to the end users' receiving apparatus.

7. A system for electronic media distribution, the system comprising:
means for generating a plurality of media items;
a data repository for storing a respective metadata item containing metadata relating to copyright and/or ownership of the corresponding media item;
means for electronically distributing at least some of the media items to a plurality of end-users;
means for detecting the copyright and/or ownership metadata relating to media items actually distributed to end-users; and
means for generating payment information indicative of a required payment to the holder of rights defined by the copyright and/or ownership metadata.

8. A system according to claim 7, in which the data repository is a database.

9. A system according to claim 7 or claim 8, in which the media items include audio and video media items.

10. A system according to any one of claims 7 to 9, comprising means for associating a material identifying code with each generated media item, the material identifying code being mapped, in the data repository, to the copyright and/or ownership metadata.

11. A system according to claim 10, in which the detecting means is operable to detect the material identifying code associated with media items to be distributed.

12. A method of electronic media distribution comprising the steps of:
generating a plurality of media items;
storing a respective metadata item containing metadata relating to the generation of the corresponding media item;
electronically distributing at least some of the media items to a plurality of end-users;
detecting reception by the end-users of the media items; and
associating, with each metadata item relating to an electronically distributed media item, a reception indicator indicative of the number of users receiving that media item.

13. A method of electronic media distribution comprising the steps of:
generating a plurality of media items;
storing a respective metadata item containing metadata relating to copyright and/or ownership of the corresponding media item;
electronically distributing at least some of the media items to a plurality of end-users;
detecting the copyright and/or ownership metadata relating to media items actually distributed to end-users; and
generating payment information indicative of a required payment to the holder of rights defined by the copyright and/or ownership metadata.

14. A method of electronic media distribution substantially as hereinbefore described with reference to the accompanying drawings.

15. Computer software comprising program code for carrying out a method according to any one of claims 12 to 14.

16. A medium by which software according to claim 15 is stored or transmitted.

17. A system for electronic media distribution substantially as hereinbefore described with reference to the accompanying drawings.
